(19) United States
(12) Patent Application Publication
(10) Pub. No.: US 2004/0001084 A1
(43) Pub. Date: Jan. 1, 2004

(54) N x M network graphical user interface and method of use

(76) Inventors: Nandini Shrinidhi, Issaquah, WA (US); Jeff Battin, Duvall, WA (US); Robert Mull, Everett, WA (US); Joe Gennaro, Federal Way, WA (US); George Harbachuk, North Bend, WA (US); Brian Nay, Maple Valley, WA (US)

Correspondence Address: L. Lawton Rogers, III, Suite 700, 1667 K Street, N.W., Washington, DC, 20006, US

(21) Appl. No.: 10/183,363

(22) Filed: Jun. 28, 2002

(51) Int. Cl. G09G 5/00

(52) U.S. Cl. 345/734

(57) ABSTRACT

A wireless PMP network may be operated, maintained, provisioned, and administered using a graphical user interface that provides access to operation, maintenance, provisioning, and administration (OAMP) functions for the wireless PMP network comprising N by M nodes. Users are allowed to select from a plurality of offered views of the PMP network. The user navigates the PMP network using user selectable display elements and may be allowed to selectively switch the user selectable perspective at any user selectable display element. In addition, a user may be allowed to selectively traverse from a first user selectable display element representing a first network node of the N by M nodes to a different OAMP perspective of that node, to another node of the N by M nodes, or the like, or a combination thereof. It is emphasized that this abstract is provided to comply with the rules requiring an abstract which will allow a searcher or other reader to quickly ascertain the subject matter of the technical disclosure. It is submitted with the understanding that it will not be used to interpret or limit the scope of meaning of the claims.

### BACKGROUND OF THE INVENTION

The present invention relates to user interfaces for viewing, navigating, and manipulating two dimensional networks. Data protocols for communication are known as “layers,” each layer representing a predefined set of communications system functionality. In certain wireless communications systems, networks of components use one or more data communications layers to form a point to multipoint (PMP) data communication system such as a PMP cellular system. These PMP systems are well known and have been in use for many wireless systems, both on the ground, in cellular mobile systems and broadband systems, as well as satellite to ground (VSAT) systems.

The advantage of a PMP network is its simplicity. Base stations transmit in a certain frequency and time slot (TDMA) over a predetermined broadcast receipt area, or “sector.” Base stations are typically installed in a location at an elevation sufficient to provide a required line of sight to all customers. Cellular phones and other cellular receivers are referred to as “nodes,” where each node communicates with a base station sectoral transceiver.

A fully meshed graphical interface allows navigation within the interface in a two dimensional manner. The user may navigate horizontally, e.g. from a hub base station perspective out to remote units, or vertically, e.g. navigating between a provisioning, operation, administration, or maintenance perspective. The user can navigate vertically, or horizontally at any time.

However, as networks grow in complexity and size, e.g. numbers of elements the comprise the network, viewing and managing the network becomes more complicated and ungainly, such as for operate, maintain, provision and administer (OAMP) functions for the network.

### BRIEF DESCRIPTION OF THE DRAWINGS

The features, aspects, and advantages of the present invention will become more fully apparent from the following description, appended claims, and accompanying drawings in which:

FIG. 1 is a schematic of a PMP network OAMP system of the present invention;

FIG. 2 is an exemplary initial GUI display of a GUI display of the present invention;

FIG. 3 is a flowchart of a method of use of the present invention;

FIG. 4 is an exemplary screen of a GUI display of the present invention;

FIG. 5 is a further exemplary screens of a GUI display of the present invention;

FIG. 6 is a further exemplary screens of a GUI display of the present invention;

FIG. 7 is a further exemplary screens of a GUI display of the present invention;

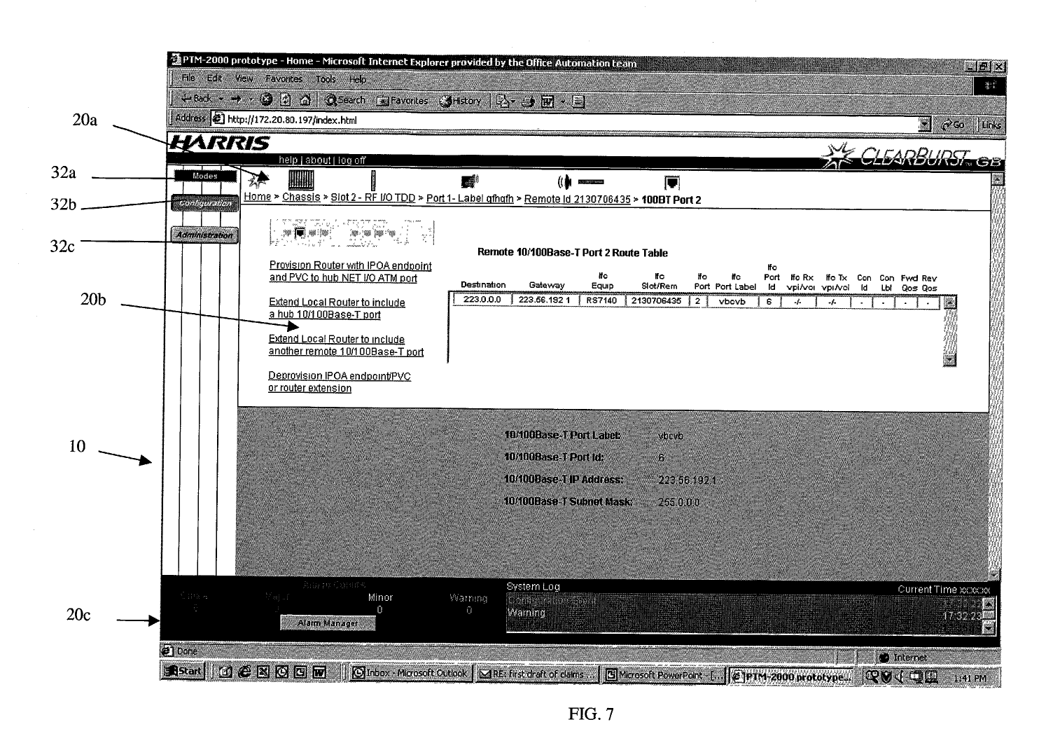

FIG. 8 is a further exemplary screens of a GUI display of the present invention; and

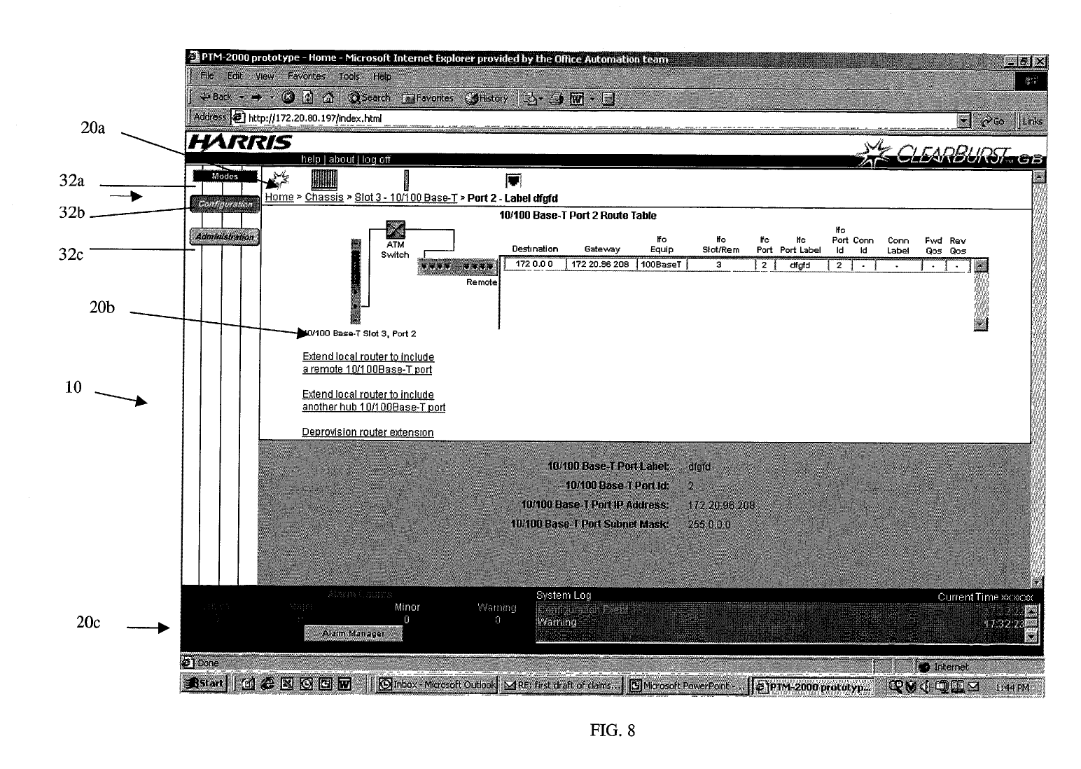

FIG. 9 is a further exemplary screens of a GUI display of the present invention.

### DETAILED DESCRIPTION OF THE PREFERRED EMBODIMENT

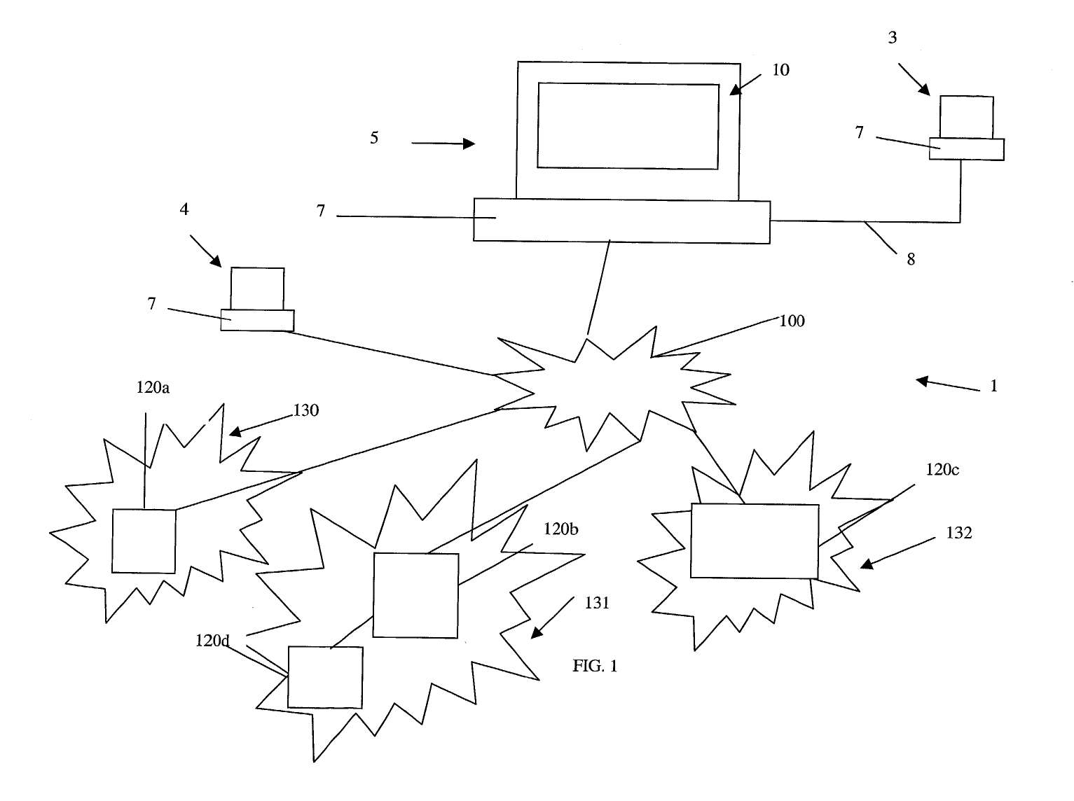

Referring now to FIG. 1, graphical user interface 10 (GUI 10) is useful for operate, maintain, provision and administer (OAMP) functions for system 1 comprising wireless point to multi-point (PMP) network 100 comprising N by M nodes 120, and computer 5 operatively connected to OAMP software 7 capable of providing OAMP functions for PMP network 100. OAMP system 7 may be software executing entirely or partially within computer 5. For example, portions of OAMP software 7 may be software executing in computers other than computer 5, e.g. computer 3 which communicates with computer 5 over local area network 8, computer 4 which communicates with computer 5 over PMP network 100, or the like, or combinations thereof. As will be familiar to those of ordinary skill in the computer arts, computer 5 further comprises display 9 on which GUI 10 is displayed.

As shown in FIG. 1, in a wireless mesh network, broadband wireless networks have the potential of delivering a multitude of services to customers at diverse locations. As millimeter wave transmission depends on line of sight between communicating transmitters and receivers, network operators may build a network, e.g. 100, which covers large topographical area and offer connectivity services to customers in line of sight relation in a region, e.g. sectors 130, 131, 132.

Point to multipoint wireless systems (“PMP” systems) are based on series of base stations 120a,120b,120c with sectoral transmitters and receivers covering cells split into sectors 130,131,132 which include customers, e.g. such as 120b, whose transceivers are facing towards a sectoral antenna of a base station, e.g. 120a, 120, 120c.

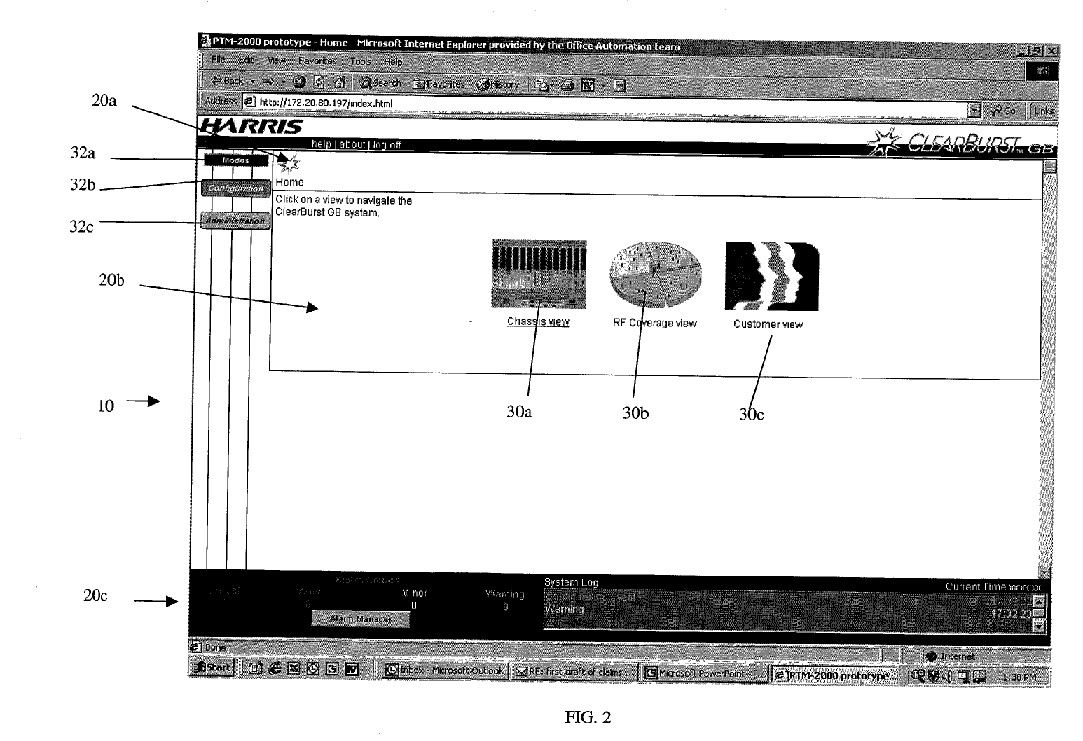

Referring now to FIG. 2, GUI 10 comprises one or more user selectable display regions 20, such as 20a, 20b, and 20c, displayed on display 9 (FIG. 1) and a plurality of user selectable display elements 30, e.g. 30a, 30b, 30c, 32a, 32b, and 32c. As used herein, a user selectable display element 30 may be an icon, a picture, a hypertext link, a button, a graphical element, a selectable area of a screen display, or the like. User selectable display element 30 may relate to a predetermined node 120 (FIG. 1) of the N by M nodes 120 to graphically depict a user selectable portion of PMP network 100 on display 9.

A user selectable portion of PMP network 100 may be presentable in a plurality of views using GUI 10. In a preferred embodiment, GUI 10 is fully meshed to allow navigation within GUI 10 in a two dimensional manner. The user may navigate horizontally, e.g. from a perspective of base station 120a,120b,120c (FIG. 1) out to remote units, e.g. 120d (FIG. 1), or vertically, e.g. navigating between a provisioning, operation, administration, or maintenance perspective. The user can navigate vertically or horizontally at any time.

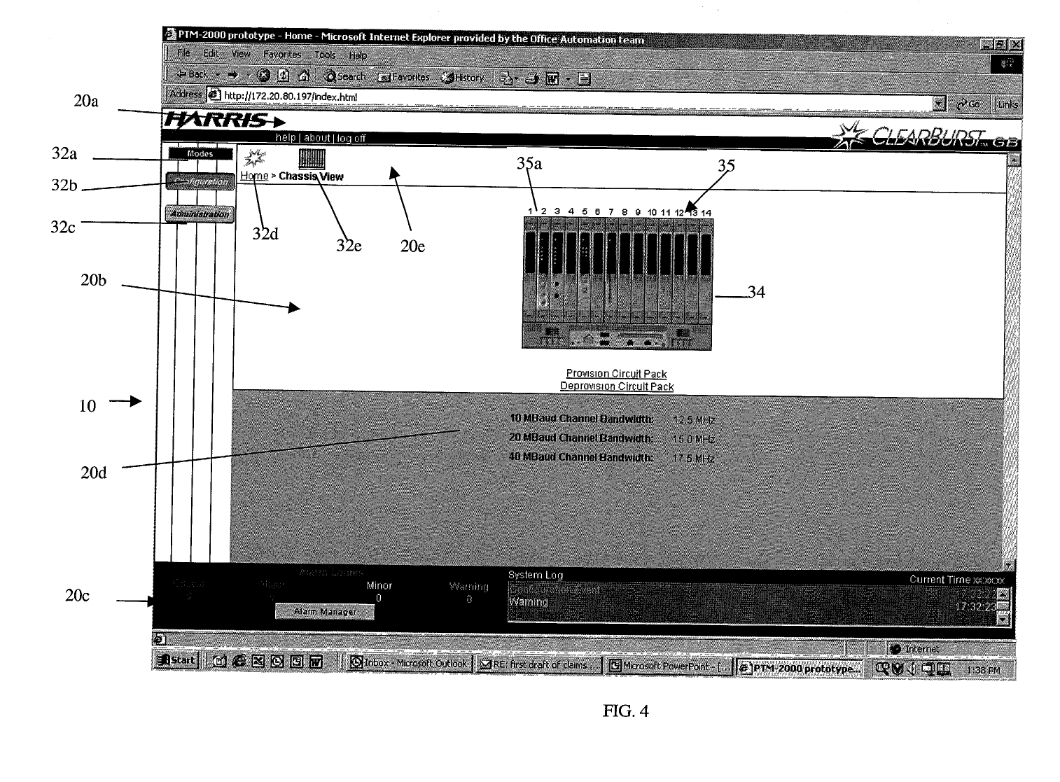

User selectable display elements 30 may be representative of hardware, such as a chassis (FIG. 4), air link performance, billing information, and the like. Further, the user may be allowed to select a perspective such as users in sector 130,131,132 (FIG. 1) of PMP network 100, relative location of remotes in a sector, , e.g. 120d in sector 131 (FIG. 1), capacity of a sector, e.g. 130,131,132, real time performance of a sector, e.g. 130,131,132, and the like.

In an embodiment, GUI 10 may logically aggregate base stations and a predetermined number of remotes which are complements of that base station, e.g. base station 120b (FIG. 1) and remote 120d (FIG. 1), as a complete network for display.

User selectable display elements 30 may also be used to control one or more views of PMP network 100, e.g. user selectable display elements 30a, 30b, and 30c. The plurality of views may include a chassis view selectable such as with user selectable display element 30a, a radio frequency (RF) coverage view selectable such as with user selectable display element 30b, a customer view selectable such as with user selectable display element 30c, or the like, or combinations thereof.

In a preferred embodiment, a plurality of user selectable display regions 20, e.g. 20a, 20b, 20c, may be displayed as either overlapped user selectable display regions 20, cascaded user selectable display regions 20, one or more partially hidden user selectable display regions 20, and the like.

Additionally, OAMP perspectives may be selected for display using GUI 10 where the OAMP perspectives may include a fault management perspective, a performance perspective, an administration perspective, a configuration perspective, or the like, such as by using user selectable display elements 30.

In a preferred embodiment, wireless PMP network 100 may include network 100 operating in the millimeter wave frequency spectrum, a time division multiple access system for communicating data in a frame format, a time-division duplex system, an adaptive time division duplex system, a network having dynamically variable data density within a frame, a network with a dynamically configurable forward/reverse ratio, or the like, or combinations thereof.

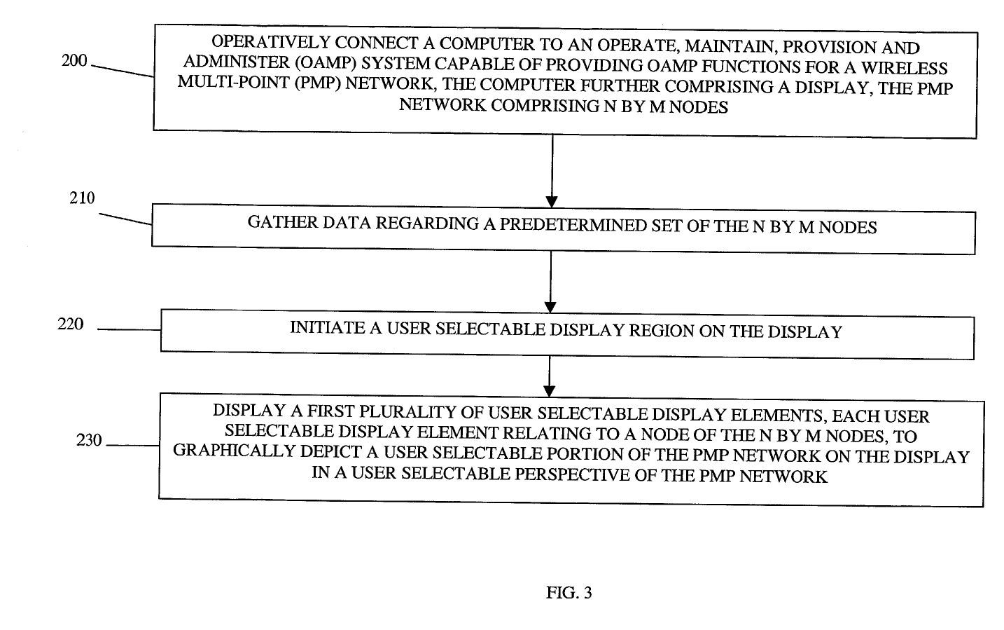

In the operation of an exemplary embodiment, referring now to FIG. 3, wireless PMP network 100 may operated, maintained, provisioned, and administered using GUI 30 by operatively connecting computer 5 (FIG. 1) to operate, maintain, provision and administer (OAMP) software 7 (FIG. 1) capable of providing OAMP functions for wireless PMP network 100, step 200.

Data regarding a predetermined set of N by M nodes 120 are then gathered, step 210, and user selectable display region 20 on the display 9 is initiated, step 220, such as with an initial display (an example of which is shown in FIG. 2). For example, a use may be allowed to select from a plurality of offered views of the PMP network 100, e.g. as shown in FIG. 2, a chassis view, an RF coverage view, and a customer view may be presented for the user to select via user selectable display elements 30a, 30b, and 30c. A user may further be allowed to view a customer perspective, e.g. 30c (FIG. 2) to selectively aggregate a plurality of user selectable display elements 30 to be configured for a predetermined customer.

A first plurality of user selectable display elements 30 are then displayed, step 230, where user selectable display element 30 may relate to a node 120 of the N by M nodes 120, to graphically depict a user selectable portion of PMP network 100 on display 9 (FIG. 1) in a user selectable perspective of PMP network 100, e.g. one of 30a, 30b, and 30c (FIG. 2).

Referring to FIG. 4, access to a user selectable display element 30 representative of a predetermined portion of hub, e.g. 120b in FIG. 1, may be provided when a predetermined alarm condition exists for the predetermined portion of the hub, e.g. in display region 20c. User selectable display element 30 for such a predetermined portion of the hub may be viewable at all times from all perspectives 30a, 30b, 30c (FIG. 2) when the predetermined alarm condition exists for the predetermined portion of the hub. In alarm conditions, a user may be further allowed to select a predetermined user selectable display element 30, e.g. one representative of a predetermined portion of the hub. In response to the selection, GUI 10 may invoke a predetermined function relating to a condition giving rise to the alarm.

In addition, a second plurality of user selectable display elements 30 may be provided, such as in display region 20e, where the second plurality of user selectable display elements 30, e.g. 30d and 30e, are related to a history of the user's selection of user selectable display elements 30 from the first set of user selectable display elements 30. If present, a user may be allowed to select a user selectable display element 30d,30e of the second plurality of user selectable display elements 30 whereupon GUI 10 returns to a previously selected user selectable display element 30 and its context or view based on the selected user selectable display element 30d,30e of the second plurality of user selectable display elements 30. In an embodiment, the second plurality of user selectable display elements 30d,30e are displayed in a display region 20 separate from the first set of user selectable display elements 30, e.g. region 20e.

A user may be allowed to selectively switch a user selectable perspective at any user selectable display element 30. In addition, a user may be allowed to selectively traverse from a first user selectable display element 30 representing a first network node 120 of the N by M nodes 120 to a different OAMP perspective of that node 120, to another node 120 of the N by M nodes 120, or the like, or a combination thereof. In a preferred embodiment, the user may select a user selectable display element 30 that causes a linkage to occur to the other view, e.g. to a universal resource locator (URL) referenced HTML page.

When navigating PMP network 100 using GUI 10, a user may be allowed to selectively switch selective navigation from hub chassis to remote via air link. For example, the user can traverse laterally from base station 120a,120b,120c (FIG. 1) out to a specific remote or remote port, e.g. remote 120d (FIG. 1), but at any time traverse vertically between the administration, provisioning, operation, or maintenance view of the then present node, such as by selecting an appropriate user selectable display element 30.

In a exemplary embodiment, a user may be presented with an initial view in GUI 10, e.g. as shown in FIG. 2. As exemplified in FIG. 4, the user, having selected a chassis view such as with 30a (FIG. 2), is presented with user selectable display element 34 indicating a chassis comprising a plurality of user selectable display elements 35, each related to a separate component in the chassis. Additional information may be presented in regions 20d and 20e concerning PMP network 100 and the selected chassis. A user may navigate to a desired component in the chassis by selecting user selectable display element 35 associated with the desired component, e.g. user selectable display element 35a.

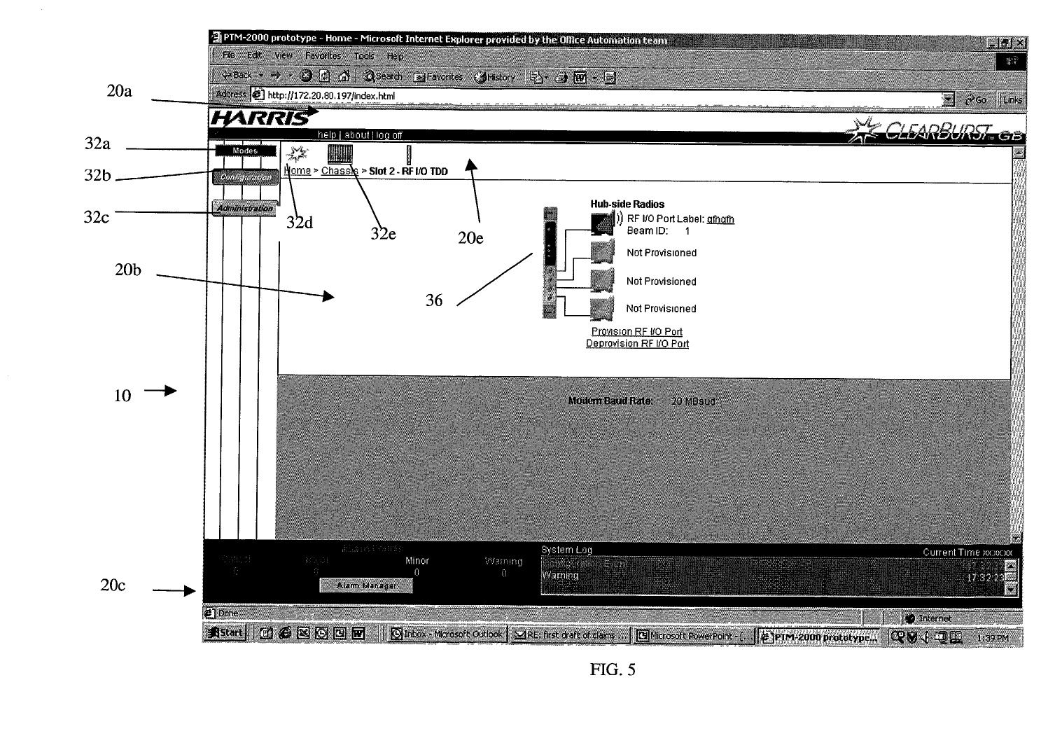

Referring now to FIG. 5, upon selection of user selectable display element 35a, a desired component is displayed in region 20b, along with information relevant to the selected component in display region 20d. As described herein above, the user may select user selectable display element 32a, 32b, or 32c in display region 20e to immediately return to that view.

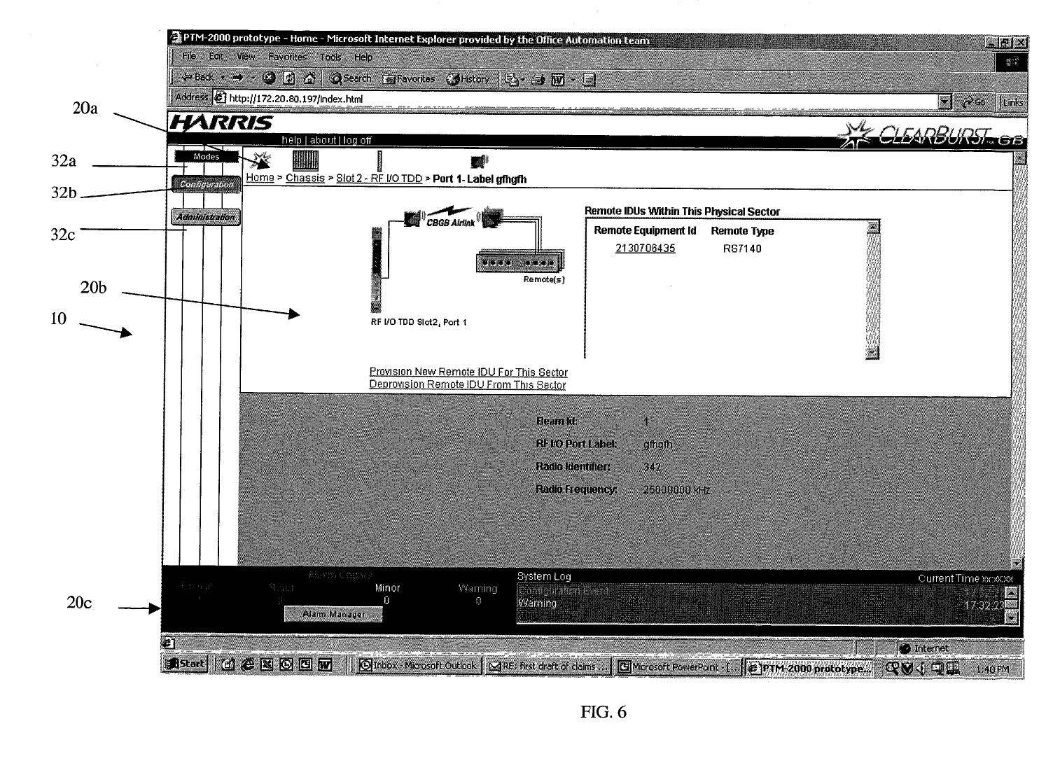

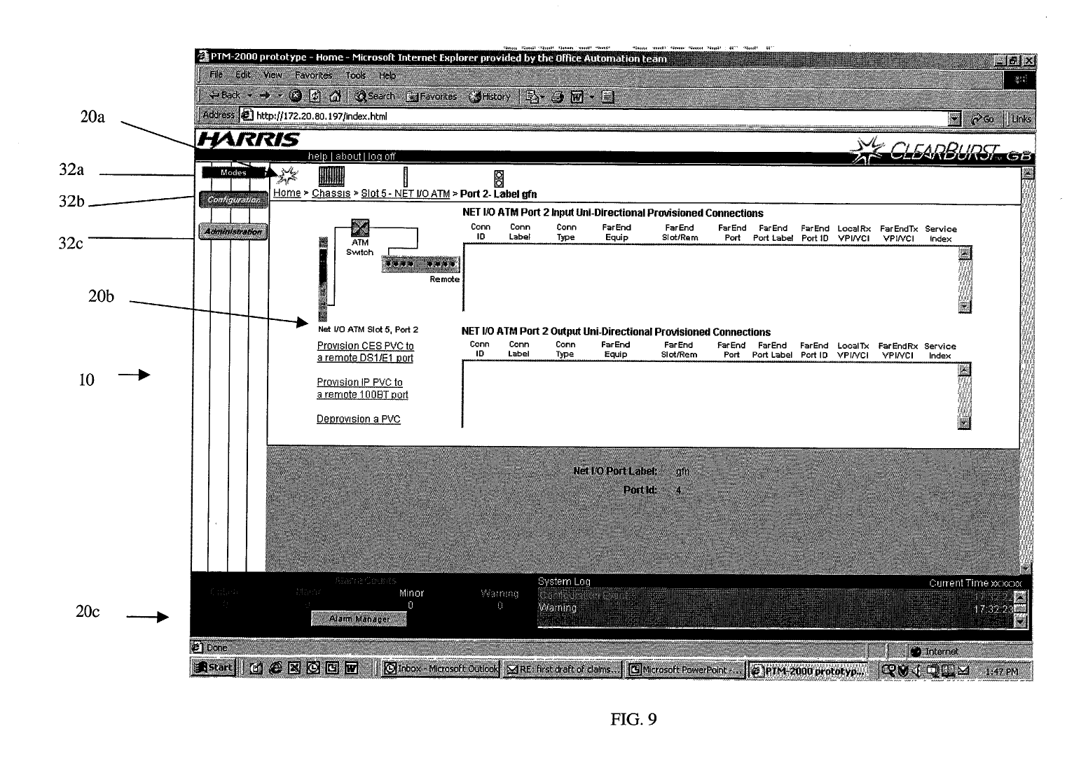

As further shown in FIG. 6 though FIG. 9, the user can continue to select user selectable display elements 30 to have access to OAMP functions for components of PMP network 100.

In a customer view (not shown in the figures), base station 120a,120b,120c (FIG. 1) and its compliment of remotes, e.g. remote 120d in FIG. 1, are owned and operated by one operating entity, e.g. a local exchange carrier or Internet service provider. A customer view would offer only the relevant customer data to the network operations center operator, rather than all of the data presented in an equipment view. For example, remote terminations may be grouped together by the respective customers leasing the terminations. A customer view would allow network operation center operators to effectively “filter” on a specific customer, showing only the ports, remotes, connections, operations/administration states, performance monitoring, and the like that apply to that customer.

In an RF view (not shown in the figures), information useful for deployment and/or frequency planning may be presented. For example, an RF might present a two or three dimension map of a geographical area, e.g. a city, in which a local exchange carrier or Internet service provider was deployed. Data shown in the RF view may then be useful to the local exchange carrier or Internet service provider in determining current and future coverage, location of remotes 120d (FIG. 1), boundaries of sectors 130,131,132 (FIG. 1), transmission power at certain points within each sector 130,131,132, distances between base station 120a,120b,120c and remotes 120d, ranges of allowable modulation for remote 120d such as a maximum based on distance, remaining available capacity on remote 120d based on its current connection provisioning and modulation index, allowable adjacent channel assignment so that interference with other sectors is minimized, and the like, or combinations thereof.

It will be understood that various changes in the details, materials, and arrangements of the parts which have been described and illustrated above in order to explain the nature of this invention may be made by those skilled in the art without departing from the principle and scope of the invention as recited in the following claims.

We claim:

1) A graphical user interface (GUI) useful for operate, maintain, provision and administer (OAMP) functions for a system comprising a wireless point to multi-point (PMP) network comprising N by M nodes, and a computer operatively connected to an OAMP system capable of providing OAMP functions for the PMP network, the computer further comprising a display, the GUI comprising:
a. a user selectable display region displayed on the display; and
b. a plurality of user selectable display elements, each user selectable display element relating to a predetermined node of the N by M nodes to graphically depict a user selectable portion of the PMP network on the display.

2) A GUI according to claim 1, wherein:
a. the GUI is fully meshed and traversing.

3) A GUI according to claim 1, wherein:
a. the GUI treats a base station and a predetermined number of remotes which are complements of the base station as a complete network.

4) A GUI according to claim 1, wherein:
a. the user selectable display region comprises a plurality of user selectable display regions displayed on the display.

5) A GUI according to claim 4, wherein:
a. the plurality of user selectable display regions displayed on the display are at least one of (i) overlapped user selectable display regions displayed on the display, (ii) cascaded user selectable display regions displayed on the display, and (iii) at least partially hidden user selectable display regions.

6) A GUI according to claim 1 wherein:
a. user selectable portion of the PMP network is presentable in a plurality of views.

7) A GUI according to claim 2, wherein:
a. the plurality of views comprises at least one of (i) a chassis view, (ii) a radio frequency (RF) coverage view, and (iii) a customer view.

8) A GUI according to claim 1, wherein:
a. the wireless PMP network is at least one of (i) a network operating in the millimeter wave frequency spectrum, (ii) a time division multiple access system for communicating data in a frame format, and (iii) a time-division duplex system, (iv) an adaptive time division duplex system, (v) a network having dynamically variable data density within a frame, and (vi) a network with a dynamically configurable forward/reverse ratio.

9) A method of operating, maintaining, provisioning, and administering a wireless point to multi-point (PMP) network comprising N by M nodes using a graphical user interface (GUI), the GUI allowing selective viewing of a perspective of the network, comprising:
a. operatively connecting a computer to an operate, maintain, provision and administer (OAMP) system capable of providing OAMP functions for a wireless multi-point (MP) network, the computer further comprising a display, the PMP network comprising N by M nodes;
b. gathering data regarding a predetermined set of the N by M nodes;
c. initiating a user selectable display region on the display;
d. displaying a first plurality of user selectable display elements, each user selectable display element relating to a node of the N by M nodes, to graphically depict a user selectable portion of the PMP network on the display in a user selectable perspective of the PMP network.

10) A method according to claim 9, further comprising:
a. providing access to a user selectable display element representative of a predetermined portion of a hub when a predetermined alarm condition exists for the predetermined portion of the hub; and
b. making the user selectable display element viewable at all times from all perspectives when the predetermined alarm condition exists for the predetermined portion of the hub.

11) A method according to claim 10, further comprising:
a. allowing a user to select the user selectable display element; and
b. responding with a predetermined function relating to a condition giving rise to the alarm.

12) A method according to claim 9, further comprising:
a. allowing a user viewing a customer perspective to selectively aggregate a plurality of user selectable display elements to be configured for a predetermined customer.

13) A method according to claim 12, wherein:
a. a user selectable display element is at least one of (i) hardware, (ii) air link performance, and (iii) customer information.

14) A method according to claim 9, further comprising:
a. providing a second plurality of user selectable display elements, the second plurality of user selectable display elements being related to a history of the user's selection of user selectable display elements from the first set of user selectable display elements;
b. allowing a user to select a user selectable display element of the second plurality of user selectable display elements; and
c. returning to a previously selected user selectable display element based on the selected user selectable display elements of the second plurality of user selectable display elements.

15) A method according to 14, wherein:
a. the second plurality of user selectable display elements are displayed in a display region separate from the first set of user selectable display elements.

16) A method of claim 9, wherein:
a. the user selectable perspective includes at least one of (i) users in a sector of the PMP network, (ii) relative location in the sector, (iii) capacity of the sector, and (iv) real time performance of the sector.

17) A method of claim 9, further comprising:
a. allowing a user to selectively switch the user selectable perspective at any user selectable display element.

18) A method of claim 9, further comprising:
a. allowing a user to selectively traverse from a first user selectable display element representing a first network node of the N by M nodes to at least one of (i) a different OAMP perspective of that node or (ii) to another node of the N by M nodes.

19) A method according to claim 18, wherein:
a. The OAMP perspectives include at least one of (i) a fault management perspective, (ii) a performance perspective, (iii) an administration perspective, and (iv) a configuration perspective.

20) A method of claim 9, further comprising:
a. allowing a user to selectively switch selective navigation from hub chassis to remote via air link.

21) A computer program embodied within a computer-readable medium created using the method of claim 9.
